(19) United States
(12) Patent Application Publication
(10) Pub. No.: US 2011/0102399 A1
(43) Pub. Date: May 5, 2011

(54) PLASMA DISPLAY PANEL AND METHOD FOR MANUFACTURING THE SAME

(76) Inventors: Ryota Hamada, Hyogo (JP); Yasuhisa Ishikura, Osaka (JP); Eiichi Uriu, Osaka (JP); Tomohiro Murakoso, Hyogo (JP)

(21) Appl. No.: 12/673,836

(22) PCT Filed: Jun. 29, 2009
(86) PCT No.: PCT/JP2009/002984

§ 371 Date: Feb. 17, 2010

(30) Foreign Application Priority Data
Jun. 30, 2008 (JP) 2008-170072

(51) Int. Cl. G09G 3/28; G06F 3/038

(52) U.S. Cl. 345/211; 345/60

(57) ABSTRACT

The present invention provides a plasma display panel having a low-cost transparent electrode, without decrease in yield. To achieve above, the panel has a first bus electrode, a second bus electrode, a first transparent electrode, and a second transparent electrode on the front substrate. The first transparent electrode covers at least a part of the first bus electrode, and similarly, the second transparent electrode covers at least a part of the second bus electrode.

### TECHNICAL FIELD

The present invention relates to an AC surface discharge-type plasma display panel used for a display device and also relates to a method for manufacturing the panel.

### BACKGROUND ART

An AC surface discharge-type plasma display panel, which has become dominance in plasma display panel (hereinafter simply referred to as a panel), has a front plate and a back plate oppositely disposed with each other and a plurality of discharge cells therebetween. The front plate has a glass front substrate, display electrode pairs each of which formed of a pair of a scan electrode and a sustain electrode, a dielectric layer and a protective layer that cover them. The back plate has a glass back substrate, data electrodes, a dielectric layer that covers the electrodes, barrier ribs, and phosphor layers. The front plate and the back plate are oppositely disposed and sealed with each other so that the display electrode pairs are located orthogonal to the data electrodes. The discharge space formed between the two plates is filled with discharge gas. The discharge cells are formed at which the display electrode pairs face the data electrodes. In the panel with the structure above, a gas discharge is generated in each discharge cell to excite phosphors of red, green, and blue. Color display is thus attained.

Each of the scan electrodes and the sustain electrodes is formed in a manner that, for example, a bus electrode of a narrow stripe is disposed on a transparent electrode of a wide stripe. To form the transparent electrode, for example, a thin film of indium tin oxide (ITO) formed on the front substrate by sputtering undergoes patterning by a photolithography method so as to be formed into a stripe shape. To form the bus electrode, paste of silver (Ag) is printed into a stripe shape on the transparent electrode and then fired (for example, see patent literature 1). However, to form an indium-tin-oxide (ITO) thin film by sputtering, it needs a vacuum device and an exposure device, that is, a large production facility is required. Besides, the forming process above has a problem of low productivity and high cost.

To address the problems above, some methods for forming a transparent electrode have been introduced. For example, a dispersion liquid containing particles of metal chosen from indium (In), tin (Sn), antimony (Sb), aluminum (Al), and zinc (Zn) is applied and fired to form a transparent electrode (for example, see patent literature 2).

However, compared to a thin film of indium-tin-oxide (ITO) formed by sputtering, the aforementioned transparent electrodes formed by firing a dispersion liquid containing particles of metal have some defects: poor mechanical strength, being easily peeled-off, and being easily damaged. Therefore, simply employing the aforementioned material, instead of ITO film, has considerably decreased the yield.

### CITATION LIST

### Patent Literature

PATENT LITERATURE 1: Unexamined Japanese Patent Publication No. 2000-156168
PATENT LITERATURE 2: Unexamined Japanese Patent Publication No. 2005-183054

### SUMMARY OF THE INVENTION

The plasma display panel of the present invention has a scan electrode, which contains a first bus electrode and a first transparent electrode, and a sustain electrode, which contains a second bus electrode and a second transparent electrode, on the front substrate. The first bus electrode and the second bus electrode are disposed on the front substrate. The first transparent electrode is disposed on the front substrate so as to cover at least a part of the first bus electrode. The second transparent electrode is disposed on the front substrate so as to cover at least a part of the second bus electrode.

Employing the structure above allows a panel to have a low-cost transparent electrode without decrease in yield.

### BRIEF DESCRIPTION OF THE DRAWINGS

FIG. 1 is an exploded perspective view showing the structure of a panel in accordance with a first exemplary embodiment of the present invention.

FIG. 2A is a front view of the panel, seen from the front plate side, showing the detailed structure of the display electrode pairs.

FIG. 2B is a sectional view of the front plate showing the detailed structure of the display electrode pairs of the panel.

FIG. 3A is a view illustrating a method for manufacturing the front plate of the panel.

FIG. 3B is a view illustrating the method for manufacturing the front plate of the panel.

FIG. 3C is a view illustrating the method for manufacturing the front plate of the panel.

FIG. 3D is a view illustrating the method for manufacturing the front plate of the panel.

FIG. 3E is a view illustrating the method for manufacturing the front plate of the panel.

FIG. 4A is a view illustrating the method for manufacturing the back plate of the panel.

FIG. 4B is a view illustrating the method for manufacturing the back plate of the panel.

FIG. 4C is a view illustrating the method for manufacturing the back plate of the panel.

FIG. 4D is a view illustrating the method for manufacturing the back plate of the panel.

FIG. 4E is a view illustrating the method for manufacturing the back plate of the panel.

FIG. 5A is a front view of a panel, seen from the front plate side, showing the detailed structure of the display electrode pairs in accordance with a second exemplary embodiment of the present invention.

FIG. 5B is a sectional view of the front plate showing the detailed structure of the display electrode pairs of the panel.

FIG. 6A is a front view of a panel, seen from the front plate side, showing the detailed structure of the display electrode pairs in accordance with a third exemplary embodiment of the present invention.

FIG. 6B is a sectional view of the front plate showing the detailed structure of the display electrode pairs of the panel.

FIG. 7A is a front view of a panel, seen from the front plate side, showing the detailed structure of the display electrode pairs in accordance with a fourth exemplary embodiment of the present invention.

FIG. 7B is a sectional view of the front plate showing the detailed structure of the display electrode pairs of the panel.

### DETAILED DESCRIPTION OF THE PREFERRED EMBODIMENTS

Exemplary embodiments of the present invention will be described hereinafter with reference to the accompanying drawings.

### First Exemplary Embodiment

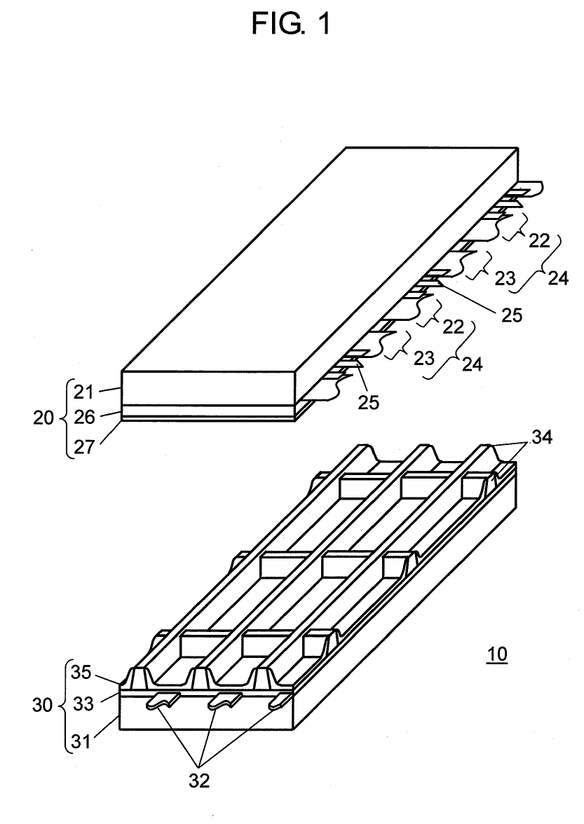

FIG. 1 is an exploded perspective view showing the structure of the panel in accordance with the first exemplary embodiment of the present invention. Panel 10 has a structure where oppositely disposed front plate 20 and back plate 30 are sealed at the peripheries with sealing material (not shown) and a plurality of discharge cells are formed inside.

Front plate 20 has glass-made front substrate 21, display electrode pairs 24 formed of scan electrodes 22 and sustain electrodes 23, black stripes 25, dielectric layer 26, and protective layer 27. On front substrate 21, display electrode pairs 24, each of which is a pair of scan electrode 22 and sustain electrode 23, are formed in parallel with each other. Besides, black stripe 25 is formed between adjacent display electrode pairs 24. Although FIG. 1 shows an arrangement of display electrode pairs 24 and black stripe 25, where scan electrode 22, sustain electrode 23, black stripe 25, scan electrode 22, sustain electrode 23, black stripe 25 are repeatedly disposed in the order named, it is not limited to; display electrode pairs 24 and black stripe 25 may be arranged in the following order: scan electrode 22, sustain electrode 23, black stripe 25, sustain electrode 23, scan electrode 22, black stripe 25, scan electrode 22, sustain electrode 23, black stripe 25, sustain electrode 23, scan electrode 22, black stripe 25, and so on.

Dielectric layer 26 is formed so as to cover display electrode pairs 24 and black stripes 25, and protective layer 27 is formed over dielectric layer 26.

Back plate 30 has glass-made back substrate 31, data electrodes 32, base dielectric layer 33, barrier ribs 34, and phosphor layers 35. On back substrate 31, a plurality of data electrodes 32 are formed in parallel with each other. Base dielectric layer 33 is formed so as to cover data electrodes 32, and grid-like barrier ribs 34 are formed on base dielectric layer 33. In addition, phosphor layers 35 of red, green, and blue are formed on the surface of base dielectric layer 33 and on the side surface of barrier ribs 34.

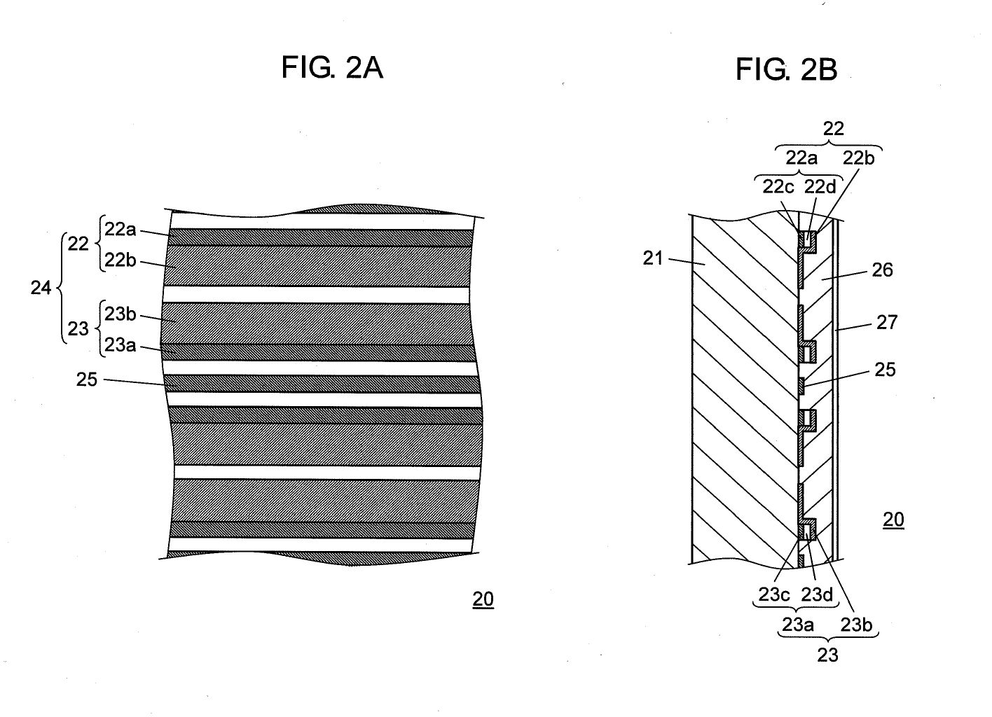

FIG. 2A is a front view of the panel, seen from the front plate side, which shows the detailed structure of the display electrode pairs in accordance with the first exemplary embodiment of the present invention. FIG. 2B is a sectional view of the front plate and shows the detailed structure of the display electrode pairs of the panel in accordance with the first exemplary embodiment of the present invention.

Scan electrode 22 has opaque first bus electrode 22a and transparent first transparent electrode 22b. First bus electrode 22a is formed of black layer 22c and conductive layer 22d. Similarly, sustain electrode 23 has second bus electrode 23a and second transparent electrode 23b. Second bus electrode 23a is formed of black layer 23c and conductive layer 23d. Hereinafter, first bus electrode 22a and second bus electrode 23a are simply referred to as bus electrode 22a and bus electrode 23a, respectively; first transparent electrode 22b and second transparent electrode 23b are referred to as transparent electrode 22b and transparent electrode 23b, respectively.

Black layers 22c, 23c are disposed for making bus electrodes 22a, 23a look black, respectively, when panel 10 is seen from the display surface side. The black layers are formed of a black material, for example, having ruthenium oxide (RuO₂) as the main component and are formed into a narrow stripe shape on front substrate 21. Conductive layers 22d, 23d enhance conductivity of bus electrodes 22a, 23a. Conductive layers 22d, 23d are formed in a manner that paste containing silver is printed on black layers 22c, 23c and then fired.

Black stripes 25 are disposed for making the display surface look black when panel 10 is seen from the display surface side. Black stripes 25 are formed of, for example, a black material containing ruthenium oxide (RuO₂) as the main component and are disposed on front substrate 21.

Transparent electrodes 22b and 23b are disposed not only for generating a strong electric field and accordingly generating a discharge in the discharge space, but also for drawing light generated from phosphor layers 35 outside panel 10. Transparent electrodes 22b and 23b are formed in a manner that a dispersion liquid containing particles of metal or particles of metal oxide is printed into a wide stripe shape so that transparent electrode 22b covers at least a part of bus electrode 22a; similarly, transparent electrode 23b covers at least a part of bus electrode 23a. After that, the applied dispersion liquid is fired in an oxidizing atmosphere.

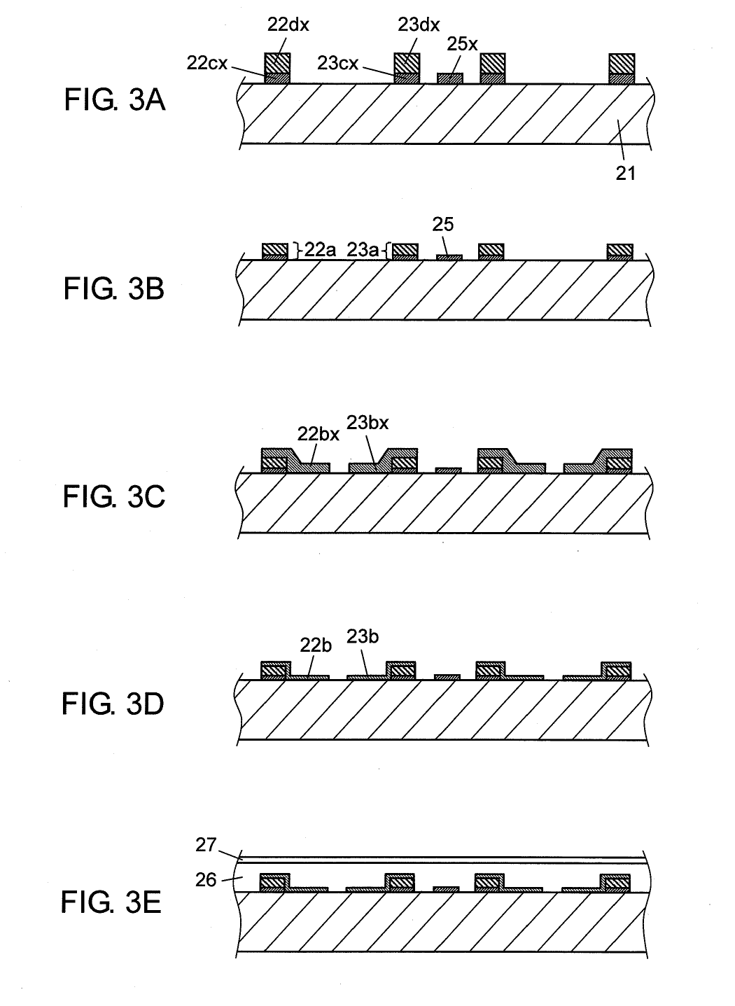

Next, the manufacturing method of panel 10 will be described. FIGS. 3A, 3B, 3C, 3D, and 3E are the views for illustrating the method for manufacturing the front plate of the panel in accordance with the first exemplary embodiment of the present invention.

As the first step of manufacturing front plate 20, glass-made front substrate 21 undergoes alkali cleaning. After that, precursors 22cx, 23cx for black layers 22c, 23c and precursor 25x for black stripe 25 are formed on front substrate 21. The precursors above are made of black layer paste containing ruthenium oxide (RuO₂) and black pigment as the main component, an organic component, and an inorganic component, such as glass frit.

The “precursor” termed in the present invention is the applied paste for structure member, such as black layer paste, that undergoes a thermal process until reaching a state where an organic component originally contained in the paste has been removed and an inorganic component does not melt.

Precursors 22cx, 23cx, and 25x are formed by heretofore known technique, such as screen printing and photolithography. After that, as shown in FIG. 3A, precursors 22dx, 23dx for conductive layers 22d, 23d are formed on precursors 22cx, 23cx. The precursors for the conductive layers are made of conductive layer paste containing silver (Ag).

Next, as shown in FIG. 3B, bus electrodes 22a, 23a and black stripe 25 are formed by firing front substrate 21 on which precursors 22cx, 23cx, 25x, 22dx, and 23dx have been formed. The peak temperature in the firing process should preferably be 550° C. to 600° C. In the embodiment, it is set at 580° C. The thickness of bus electrodes 22a, 23a should preferably be 1 to 6 μm. In the embodiment, it is determined at 4 μm.

Next, transparent electrodes 22b and 23b are formed. First, dispersion liquid containing any one of the following particles with an average particle diameter of 5-100 nm is prepared:
particles of metal formed of at least one of indium (In), tin (Sn), antimony (Sb), aluminum (Al), and zinc (Zn);
particles of alloy formed of the metals above;
particles of metal oxide formed of at least one of the metals above; and
a mixture of the particles above.

In the embodiment, the dispersion liquid is formed in a manner that particles of indium (In)-tin (Sn) alloy with an average particle diameter of 10 nm is dispersed at a concentration of 12 wt % into an organic solvent with dispersant. In the embodiment, decahydronaphthalene is used for the organic solvent. Instead, for example, the followings can be employed: nonpolar solvent, such as toluene, xylene, benzene, tetradecane; aromatic hydrocarbon group; long-chain alkane, such as hexane, heptane, octane, nonane, decane, undecane, dodecane, tridecane, tetradecane, pentadecane, hexadecane, octadecane, nonadecane, eicosane, trimethylpentane; and cyclic alkane, such as cyclohexaane, cycloheptane, cyclooctane.

Next, as shown in FIG. 3C, wet layer 22bx is formed in a manner that the dispersion liquid is applied, by an inkjet printer, into a wide stripe shape so as to cover at least a part of bus electrode 22a. Similarly, wet layer 23bx is formed in a manner that the dispersion liquid is applied into a wide stripe shape so as to cover at least a part of bus electrode 23a. In the embodiment, wet layers 22bx and 23bx are formed by an inkjet printer having a minute nozzle with a plurality of holes. In the process, the dispersion liquid is applied so that wet layer 22bx covers bus electrode 22a and wet layer 23bx covers bus electrode 23a.

After that, as shown in FIG. 3D, front substrate 21 having wet layers 22bx and 23bx is dried and fired at temperatures ranging from 400° C. to 600° C. in an oxidizing atmosphere. Through the process, transparent electrodes 22b and 23b, which are made of a transparent conductive film with a thickness of 80-1000 nm, are formed. In the embodiment, front substrate 21 having wet layers 22bx and 23bx formed thereon is dried while maintained for 10 min. at a temperature of 230° C. under reduced pressure of 1×10⁻³ Pa. After that, it is fired for 60 min. at a temperature of 500° C. in the air, so that transparent electrodes 22b and 23b, which are made of indium-tin oxide (ITO) film with a thickness of approx. 300 nm, are formed.

In this way, after bus electrodes 22a, 23a are formed, transparent electrodes 23a, 23b are formed so as to cover at least a part of bus electrodes 22a, 22b, respectively. This reduces the risk that the transparent electrodes are peeled off or damaged in the forming process of the bus electrodes. Transparent electrodes are thus formed with the use of a dispersion liquid containing particles of metal or particles of metal oxide.

Next, the precursor of the dielectric layer is formed, by printing or other heretofore known technique, on front substrate 21 on which scan electrodes 22, sustain electrodes 23, and black stripes 25 have been formed. The precursor of the dielectric layer is fired, so that dielectric layer 26 with a thickness of 20 to 50 μm is formed.

The dielectric paste formed in the embodiment contains dielectric glass having the following composition: 34.6 wt % boron oxide (B₂O₃), 1.4 wt % silicon oxide (SiO₂), 27.6 wt % zinc oxide (ZnO), 3.3 wt % barium oxide (BaO), 25 wt % bismuth oxide (Bi₂O₃), 1.1 wt % aluminum oxide (Al₂O₃), 4.0 wt % molybdenum oxide (MoO₃), and 3.0 wt % tungsten oxide (WO₃). The softening point of the dielectric glass is about 570° C. Next, the precursor of the dielectric layer is formed by applying dielectric paste, by die coating, onto front substrate 21 having scan electrodes 22, sustain electrodes 23, and black stripes 25 thereon. The precursor of the dielectric layer is then fired at about 590° C., so that dielectric layer 26 with a thickness of about 40 μm is formed.

Instead of the dielectric paste above, for example, a dielectric paste containing dielectric glass that has a softening point of 520° C. to 590° C. and contains some of the followings can be used: boron oxide (B₂O₃), silicon oxide (SiO₂), zinc oxide (ZnO), bismuth oxide (Bi₂O₃), aluminum oxide (Al₂O₃), molybdenum oxide (MoO₃), tungsten oxide (WO₃), cerium oxide (CeO), alkaline-earth metal oxide, and alkali metal oxide.

As shown in FIG. 3E, protective layer 27 having magnesium oxide (MgO) as the main component is formed on dielectric layer 26 by a vacuum deposition method or other heretofore known technique.

In the embodiment, transparent electrodes 22b and 23b are formed of indium tin oxide (ITO) with the use of particles of indium (In)-tin (Sn) alloy, but it is not limited thereto. For example, the transparent electrodes may be formed of a tin oxide (SnO₂) film with the use of particles of tin (Sn). As still another possibility, the transparent electrodes may be formed of a zinc oxide (ZnO) film with the use of particles of zinc (Zn).

In the embodiment, after precursors 22cx, 23cx, 22dx, and 23dx for black layers 22c, 23c, conductive layers 22d, 23d are fired, wet layers 22bx and 23bx are formed and fired, but it is not limited thereto. For example, scan electrodes 22 and sustain electrodes 23 may be formed in a manner that, after precursors 22cx, 23cx, 22dx, and 23dx are formed and then further wet layers 22bx and 23bx are formed on the precursors, the precursors 22cx, 23cx, 22dx, 23dx, wet layers 22bx, 23bx are fired at the same time.

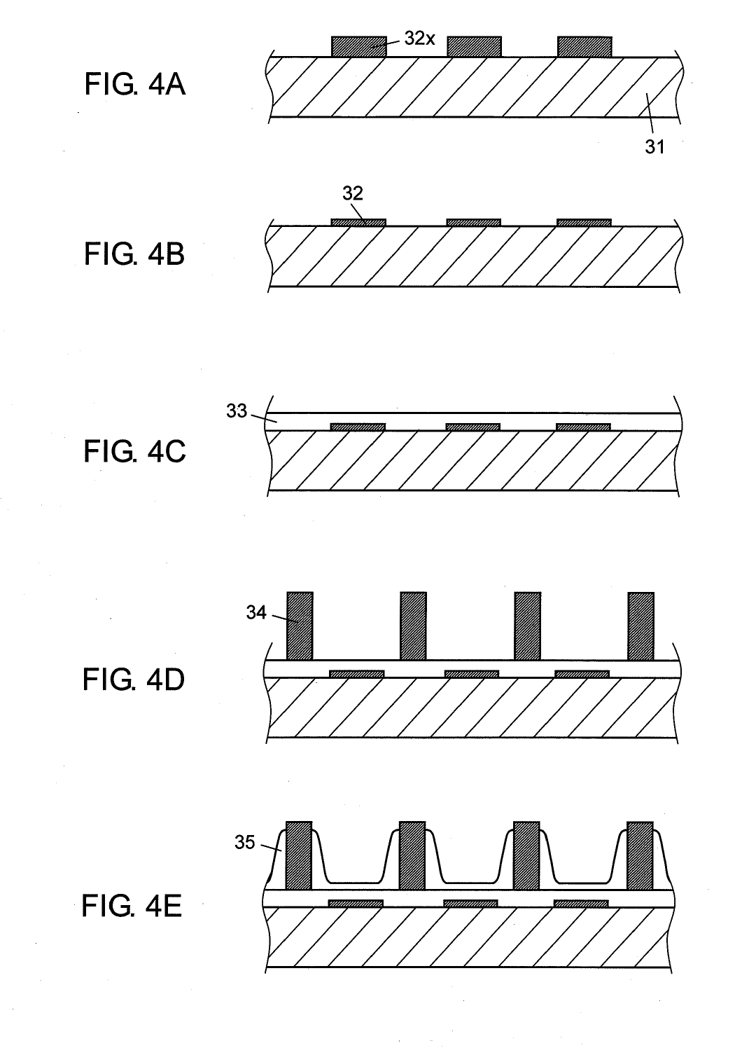

Next, the method for manufacturing back plate 30 will be described. FIGS. 4A, 4B, 4C, 4D, and 4E illustrate the method for manufacturing the back plate of the panel in accordance with the first exemplary embodiment of the present invention.

First, as shown in FIG. 4A, conductive layer paste having silver as the main component is applied onto back substrate 31 so as to have an, evenly spaced stripe shape by heretofore known technique, for example, screen printing and photolithography. Precursors 32x for data electrodes 32 are thus formed.

Next, as shown in FIG. 4B, data electrodes 32 are formed by firing back substrate 31 having precursors 32x thereon. Data electrode 32 has a thickness of, for example, 2 to 10 μm.

Next, as shown in FIG. 4C, dielectric paste is applied onto back substrate 31 having data electrodes 32 thereon and then fired so as to form base dielectric layer 33. Base dielectric layer 33 has a thickness of, for example, approx. 5 to 15 μm.

Next, as shown in FIG. 4D, after photosensitive dielectric paste is applied onto back substrate 31 having base dielectric layer 33 thereon, the paste is dried so as to form the precursor of barrier ribs 34. After that, barrier ribs 34 are formed by photolithography or other heretofore known technique. Barrier ribs 34 have a height of, for example, 100 to 150 μm.

Next, as shown in FIG. 4E, phosphor ink containing any one of red, green, and blue phosphors is applied to the wall surface of barrier ribs 34 and the surface of dielectric layer 33. After that, the ink is dried and then fired so as to form phosphor layers 35.

A red phosphor may be formed of, for example, (Y, Gd) BO₃:Eu, (Y, V) PO₄:Eu. A green phosphor may be formed of, for example, Zn₂SiO₄:Mn, (Y, Gd) BO₃:Tb, (Y, Gd) Al₃(BO₃)₄:Tb. A blue phosphor may be formed of, for example, BaMgAl₁₀O₁₇:Eu, Sr₃MgSi₂O₈:Eu.

Front plate 20 and back plate 30 are oppositely disposed so that display electrode pairs 24 are positioned orthogonal to data electrodes 32. The two plates are sealed with low-melting glass at the peripheries outside the image display area where the discharge cells are formed. After that, the discharge space inside the plates is filled with discharge gas containing xenon. Panel 10 is thus completed.

According to the embodiment, transparent electrodes 22b, 23b are formed in a manner that a dispersion liquid containing particles of metal, such as indium (In) and tin (Sn), is applied into a wide stripe shape so that transparent electrode 22b covers at least a part of bus electrode 22a; similarly, transparent electrode 23b covers at least a part of bus electrode 23a, and then fired in an oxidizing atmosphere. In the next step that follows above, dielectric layer 26 is formed so as to cover transparent electrodes 22b and 23b by die coating. The structure further reduces the risk of damage and peel-off of transparent electrodes 22b and 23b even when they have insufficient mechanical strength.

Besides, in the embodiment, transparent electrodes 22b and 23b are formed in a manner that a dispersion liquid containing indium (In)-tin (Sn) alloy particles with an average diameter of 10 nm is printed and then fired at a high temperature of 500° C. Such formed transparent electrodes 22b, 23b not only have low resistance, high transmittance, but also keep an intimate contact with front substrate 21 and bus electrodes 22a, 23a. This is considered that the firing process at high temperatures allows the particles to be expanded during the change from indium (In) to indium oxide (In₂O₃), enhancing the contact between the particles and between the particles and the substrate.

Besides, according to the embodiment, transparent electrodes 22b and 23b are formed of metal particles with an average particle diameter of 5 to 100 nm. Particles with an average particle diameter smaller than 5 nm easily causes reaction of the particles to the dielectric glass, and at the same time, easily causes a crack at the stepped section between the transparent electrodes and silver (Ag)-contained bus electrodes 22a, 23a. On the other hand, particles with an average particle diameter greater than 100 nm easily cause clogging in the minute nozzle of the inkjet printer. Besides, if the average particle diameter becomes excessively large, the contact area between the particles after the firing process decreases, resulting in increased sheet resistance.

According to the embodiment, a dispersion liquid containing particles of metal is printed into stripes by inkjet printing. The inkjet printing described above allows the patterning process to be completed with high dimensional accuracy and the least wasted dispersion liquid.

The amount of dispersion liquid can be further reduced by adding a twist to the shape of a transparent electrode, which is described below.

### Second Exemplary Embodiment

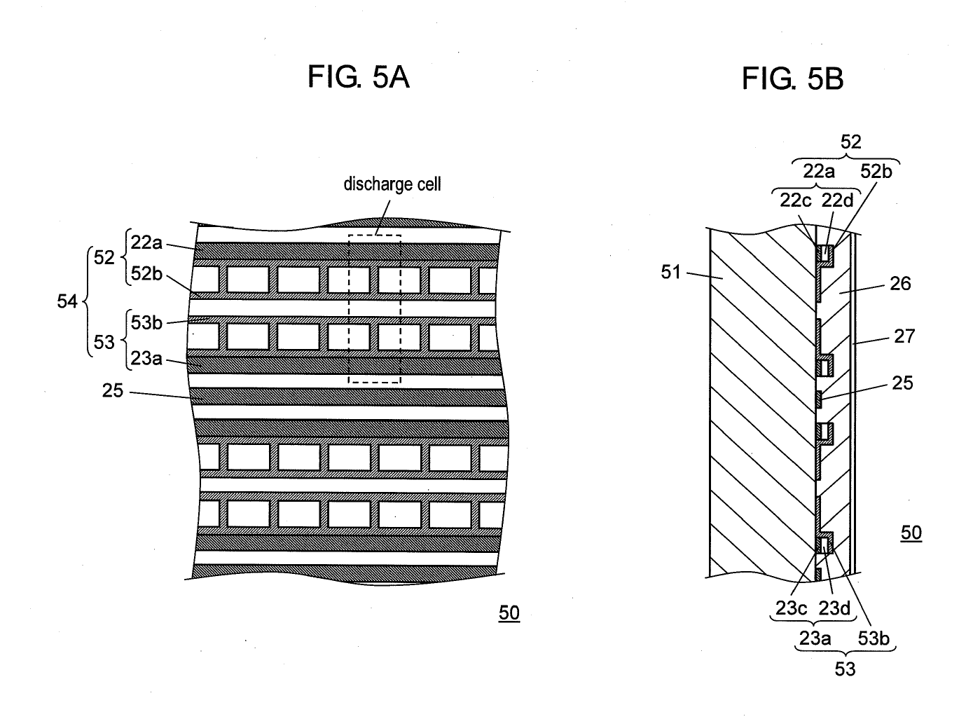

FIG. 5A is a front view of a panel, seen from the front plate side, showing the detailed structure of the display electrode pairs in accordance with the second exemplary embodiment of the present invention. FIG. 5B is a sectional view of the front plate showing the detailed structure of the display electrode pairs of the panel. The panel of the second exemplary embodiment differs from that of the first exemplary embodiment in shapes of transparent electrodes 52b, 53b formed on front substrate 51 that constitutes front plate 50. In the drawings above, like parts are identified by the same reference marks as the structure described in the first exemplary embodiment and a detailed description will be omitted.

Scan electrode 52 has bus electrode 22a and transparent electrode 52b. Similarly, sustain electrode 53 has bus electrode 23a and transparent electrode 53b. Each of display electrode pairs 54 is formed of scan electrode 52 and sustain electrode 53.

Transparent electrodes 22b, 23b are formed in a manner that a dispersion liquid containing particles of metal, such as indium (In) and tin (Sn), is applied into a wide stripe shape so that transparent electrode 22b covers at least a part of bus electrode 22a; similarly, transparent electrode 23b covers at least a part of bus electrode 23a, and then fired in an oxidizing atmosphere. Transparent electrodes 52b, 53b of the embodiment, as shown in FIG. 5A, are formed into a ladder shape so that each “step” of the “ladder” is disposed to each discharge cell. In this way, forming transparent electrodes 52b and 53b into a ladder shape contributes to a reduced amount of usage of the dispersion liquid.

### Third Exemplary Embodiment

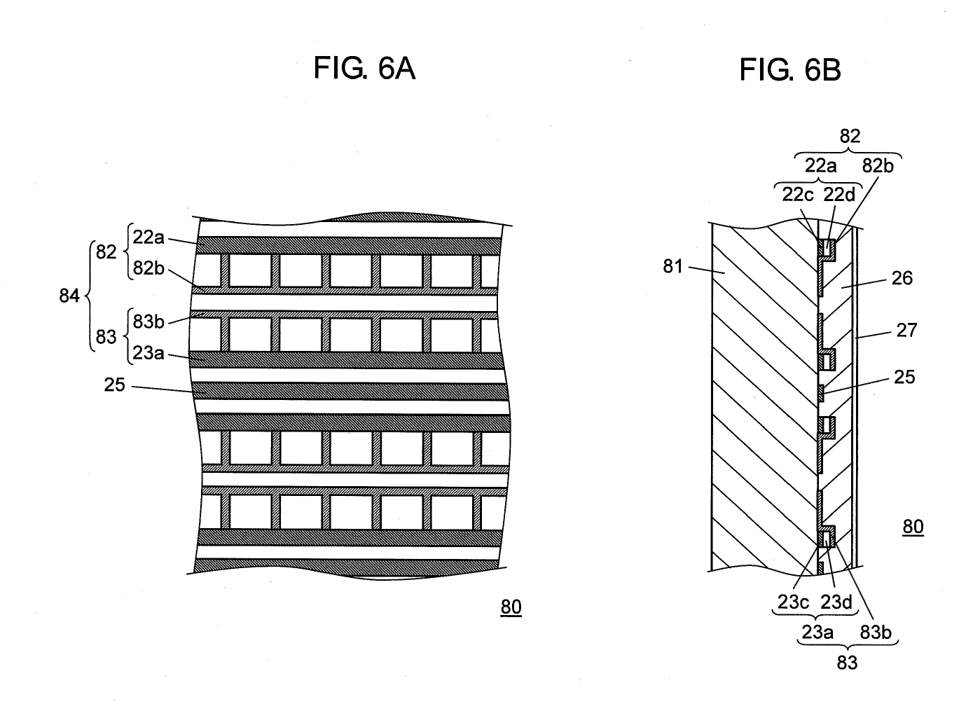

FIG. 6A is a front view of a panel, seen from the front plate side, showing the detailed structure of the display electrode pairs in accordance with the third exemplary embodiment of the present invention. FIG. 6B is a sectional view of the front plate showing the detailed structure of the display electrode pairs of the panel.

Scan electrode 82, which is formed on front substrate 81 that constitutes front plate 80, has bus electrode 22a and transparent electrode 82b. Similarly, sustain electrode 83 has bus electrode 23a and transparent electrode 83b. Each of display electrode pairs 84 is formed of scan electrode 82 and sustain electrode 83.

Transparent electrodes 82b, 83b are formed in a manner that a dispersion liquid containing particles of metal, such as indium (In) and tin (Sn), is applied into a wide stripe shape so that transparent electrode 82b covers at least a part of bus electrode 22a; similarly, transparent electrode 83b covers at least a part of bus electrode 23a, and then fired in an oxidizing atmosphere. Transparent electrodes 82b, 83b of the third exemplary embodiment, as shown in FIG. 6A, are formed into a comb shape so that each “tooth” of the “comb” is disposed to each discharge cell. In this way, forming transparent electrodes 52b and 53b into a comb shape contributes to a further reduced amount of usage of the dispersion liquid.

### Fourth Exemplary Embodiment

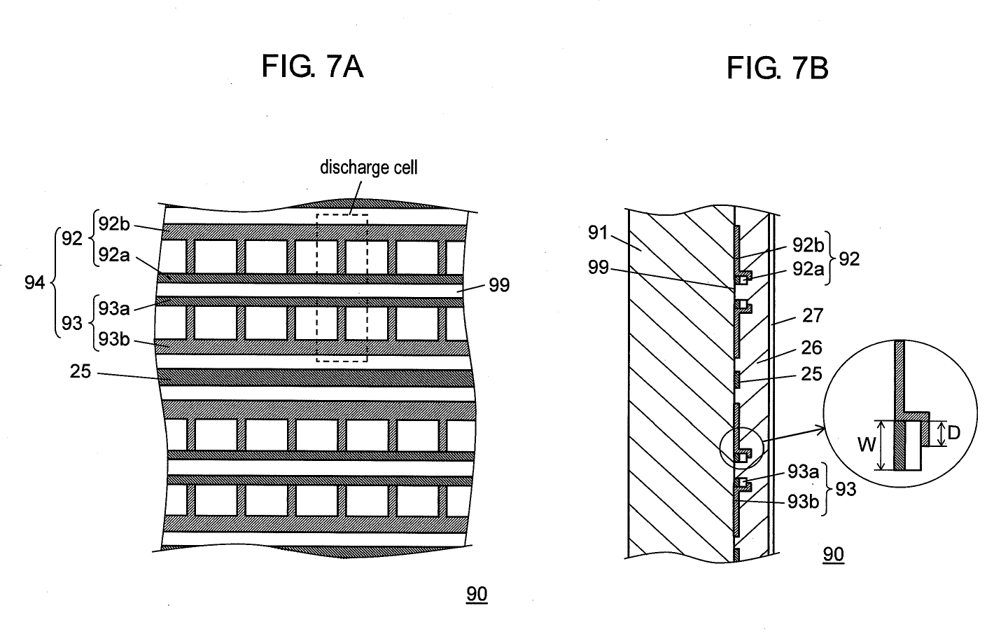

FIG. 7A is a front view of a panel, seen from the front plate side, showing the detailed structure of the display electrode pairs in accordance with the fourth exemplary embodiment of the present invention. FIG. 7B is a sectional view of the front plate showing the detailed structure of the display electrode pairs of the panel. Scan electrode 92, which is formed on front substrate 91 that constitutes front plate 90, has bus electrode 92a and transparent electrode 92b. Similarly, sustain electrode 93 has bus electrode 93a and transparent electrode 93b. Each of display electrode pairs 94 is formed of scan electrode 92 and sustain electrode 93.

Transparent electrodes 92b, 93b are formed in a manner that a dispersion liquid containing particles of metal, such as indium (In) and tin (Sn), is applied into a wide stripe shape so that transparent electrode 92b covers at least a part of bus electrode 92a; similarly, transparent electrode 93b covers at least a part of bus electrode 93a, and then fired in an oxidizing atmosphere. Transparent electrodes 92b, 93b of the embodiment, as shown in FIG. 7A, are formed into a comb shape so that each “tooth” of the “comb” is disposed to each discharge cell. In the fourth embodiment, too, forming transparent electrodes 52b and 53b into a comb shape contributes to a reduced amount of usage of the dispersion liquid, as well as the structure described in the third exemplary embodiment.

The panel of the fourth exemplary embodiment differs from that of the third exemplary embodiment in that the section between oppositely disposed scan electrode 92 and sustain electrode 93, i.e., discharge gap 99 is formed by bus electrodes 92a, 93a.

In general, the distance of a discharge gap significantly affects discharge characteristics of the discharge cell. Large variations in distance of a discharge gap due to poor dimensional accuracy in printing a transparent electrode increase variations in discharge characteristics between discharge cells. This can cause unevenness to the display surface. According to the fourth exemplary embodiment, however, bus electrodes 92a and 93a are formed by photolithography with high, dimensional accuracy. This allows variations in distance of discharge gap 99 to be decreased, thereby suppressing variations in discharge characteristics between discharge cells.

As described above, transparent electrode 92b is formed so as to cover at least a part of bus electrode 92a, and similarly, transparent electrode 93b is formed so as to cover at least a part of bus electrode 93a. In the forming process above, it is preferable that each width of transparent electrodes 92b and 93b overlapped with bus electrodes 92a and 93a, respectively, should be at least half each width of transparent electrodes 92b, 93b and should be smaller than each width thereof. That is, the following relation should preferably be satisfied:

½W≦D<W, where, W represents the width of bus electrode 92a (93a); D represents an overlapped width between transparent electrode 92b (93b) and bus electrode 92a (93a).

If transparent electrodes 92b, 93b are formed so as to completely cover bus electrodes 92a, 93a, silver particles as the material of bus electrodes can undergo insufficient sintering in the firing process of bus electrodes 92a, 93a. To avoid the problem, overlapped width D should preferably be smaller than width W of bus electrode 92a (93a). On the other hand, if overlapped width D is smaller than half width W of bus electrode 92a (93a), contact resistance between bus electrode 92a (93a) and transparent electrode 92b (93b) increases, resulting in impaired image display quality due to an excessive increase in resistance value of scan electrode 92 and sustain electrode 93. Therefore, it is not preferable that overlapped width D is determined to be smaller than half width W of bus electrode 92a (93a).

Although the “teeth” of the “comb” shape, as shown in FIG. 7A, are formed of material of transparent electrodes in the embodiment, it is not limited thereto; they may be formed, for example, of material of bus electrodes.

Besides, specific values seen in the description of the first through fourth embodiments are cited merely by way of example. They should be optimally determined according to, for example, specifications of a panel.

### INDUSTRIAL APPLICABILITY

The manufacturing method above allows the transparent electrodes to be formed, without decrease in yield, by firing a dispersion liquid containing particles of metal or particles of metal oxide. This provides a panel with low-cost transparent electrodes. It is therefore useful for manufacturing a panel and a method for manufacturing thereof.

### REFERENCE MARKS IN THE DRAWINGS

10 panel
20, 50, 80, 90 front plate
21, 51, 81, 91 front substrate
22, 52, 82, 92 scan electrode
22a, 92a (first) bus electrode
22b, 52b, 82b, 92b (first) transparent electrode
22bx, 23bx wet layer
22c, 23c black layer
22cx, 23cx precursor (for black layer)
22d, 23d conductive layer
22dx, 23dx precursor (for conductive layer)
23, 53, 83, 93 sustain electrode
23a, 93a (second) bus electrode
23b, 53b, 83b, 93b (second) transparent electrode
24, 54, 84, 94 display electrode pair
25 black stripe
25x precursor (for black stripe)
26 dielectric layer
27 protective layer
30 back plate
31 back substrate
32 data electrode
32x precursor (for data electrode)
33 base dielectric layer
34 barrier rib
35 phosphor layer
99 discharge gap

1. A plasma display panel having a structure where a scan electrode and a sustain electrode are disposed on a front substrate, the scan electrode being formed of a first bus electrode and a first transparent electrode, and the sustain electrode being formed of a second bus electrode and a second transparent electrode, the plasma display panel comprising:
the first bus electrode and the second bus electrode disposed on the front substrate;
the first transparent electrode disposed on the front substrate so as to cover at least a part of the first bus electrode; and
the second transparent electrode disposed on the front substrate so as to cover at least a part of the second bus electrode.

2. The plasma display panel of claim 1, wherein each of the first transparent electrode and the second transparent electrode is formed by using a dispersion liquid containing particles of metal or particles of metal oxide.

3. The plasma display panel of claim 2, wherein the particles contain indium and tin.

4. The plasma display panel of claim 1, wherein at least one of the first transparent electrode and the second transparent electrode is formed into a comb-teeth shape or a ladder shape.

5. A method for manufacturing a plasma display panel having a structure where a scan electrode and a sustain electrode are disposed on a front substrate, the scan electrode being formed of a first bus electrode and a first transparent electrode, and the sustain electrode being formed of a second bus electrode and a second transparent electrode, the method comprising:
forming the first bus electrode and the second bus electrode on the front substrate;
forming the first transparent electrode so as to cover at least a part of the first bus electrode or a part of a precursor of the first bus electrode; and
forming the second transparent electrode so as to cover at least a part of the second bus electrode or a part of a precursor of the second bus electrode.

6. The method for manufacturing a plasma display panel of claim 5, wherein each of the first transparent electrode and the second transparent electrode is formed by applying a dispersion liquid containing particles of metal or particles of metal oxide.

7. The method for manufacturing a plasma display panel of claim 6, wherein the dispersion liquid is applied by an inkjet method.

8. The method for manufacturing a plasma display panel of claim 5 further comprising:
forming a dielectric layer after forming the first transparent electrode and the second transparent electrode.
